(19) United States
(12) Patent Application Publication
(10) Pub. No.: US 2022/0295372 A1
(43) Pub. Date: Sep. 15, 2022

(54) TECHNIQUES FOR MOBILITY DETECTION FOR MODEM PARAMETER SELECTION

(71) Applicant: QUALCOMM Incorporated, San Diego, CA (US)

(72) Inventors: Jun Zhu, San Diego, CA (US); Mihir Vijay Laghate, San Diego, CA (US); Yongle Wu, San Diego, CA (US); Raghu Narayan Challa, San Diego, CA (US)

(21) Appl. No.: 17/677,448

(22) Filed: Feb. 22, 2022

Related U.S. Application Data
(60) Provisional application No. 63/159,874, filed on Mar. 11, 2021.

(51) Int. Cl. H04W 36/32; H04W 36/00; H04W 16/28

(52) U.S. Cl. CPC H04W 36/32; H04W 36/0072; H04W 16/28

(57) ABSTRACT

Methods, systems, and devices for wireless communications are described. Generally, to determine a mobility status of a user equipment (UE), the UE may perform filtering or post-processing on one or more beam metrics. The UE may generate first order statistics for the beam metrics, and may use the first order statistics to generate second order statistics. Based on whether the second order statistics for the beam metrics converge, based on whether a detected beam metric converges at zero or a non-zero value, or any combination thereof, the UE may determine a mobility status for the UE. The UE may select appropriate beam management parameter values based on the determined mobility status.

### CROSS REFERENCE

The present Application for Patent claims the benefit of U.S. Provisional Patent Application No. 63/159,874 by ZHU et al., entitled “TECHNIQUES FOR MOBILITY DETECTION FOR MODEM PARAMETER SELECTION,” filed Mar. 11, 2021, assigned to the assignee hereof, and which is hereby incorporated by reference in its entirety.

### FIELD OF TECHNOLOGY

The following relates to wireless communications, including techniques for mobility detection for modem parameter selection.

### FIELD OF DISCLOSURE

The present disclosure, for example, relates to wireless communication systems, more specifically to techniques for mobility detection for modem parameter selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support techniques for mobility detection for modem parameter selection. Generally, to determine a mobility status of a user equipment (UE), the UE may perform filtering or post-processing on one or more beam metrics (e.g., reference signal receive power (RSRP), signal to noise ratio (SNR), reference signal receive quality (RSRQ), or the like) over time. The UE may generate first order statistics for the beam metrics, and may use the first order statistics to generate second order statistics. For example, the UE may perform a loop tracking procedure (e.g., may periodically monitor a service cell, a serving base station beam, and a serving UE beam) to generate instantaneous and mean values for a beam metric (e.g., RSRP, SNR, RSRQ, etc.). The UE may determine, based on the mean values for the beam metrics, second order statistics (e.g., beam variance for the beam metrics). Based on whether the second order statistics for the beam metrics converge, based on whether a detected beam metric converges at zero or a non-zero value, or any combination thereof, the UE may determine a mobility status for the UE. For instance, if the second order statistics of the beam metrics converge at zero, the UE may determine that the UE is stationary, has small Doppler value, has no rotation, etc. If the second order statistics of the beam metrics converge at a non-zero constant, the UE may determine that the UE has a Doppler value, but no rotation. If the second-order statistics diverge, then the UE may determine that the UE is rotating. The UE may select appropriate beam management parameter values based on the determined mobility status.

A method for wireless communications at a user equipment (UE) is described. The method may include generating, based on one or more beam metrics for one or more beams, a set of first order statistics associated with the one or more beam metrics, generating, based on the set of first order statistics, a set of second order statistics associated with the one or more beam metrics, determining a mobility status of the UE associated with the set of second order statistics, selecting, based on the determined mobility status, one or more beam management parameters, and managing the one or more beams according to the selected one or more beam management parameters.

An apparatus for wireless communications at a UE is described. The apparatus may include a processor, memory coupled with the processor, and instructions stored in the memory. The instructions may be executable by the processor to cause the apparatus to generating, base at least in part on one or more beam metrics for one or more beams, a set of first order statistics associated with the one or more beam metrics, generating, base at least in part on the set of first order statistics, a set of second order statistics associated with the one or more beam metrics, determine a mobility status of the UE associated with the set of second order statistics, select, based on the determined mobility status, one or more beam management parameters, and manage the one or more beams according to the selected one or more beam management parameters.

Another apparatus for wireless communications at a UE is described. The apparatus may include means for generating, based on one or more beam metrics for one or more beams, a set of first order statistics associated with the one or more beam metrics, means for generating, based on the set of first order statistics, a set of second order statistics associated with the one or more beam metrics, means for determining a mobility status of the UE associated with the set of second order statistics, means for selecting, based on the determined mobility status, one or more beam management parameters, and means for managing the one or more beams according to the selected one or more beam management parameters.

A non-transitory computer-readable medium storing code for wireless communications at a UE is described. The code may include instructions executable by a processor to generating, base at least in part on one or more beam metrics for one or more beams, a set of first order statistics associated with the one or more beam metrics, generating, base at least in part on the set of first order statistics, a set of second order statistics associated with the one or more beam metrics, determine a mobility status of the UE associated with the set of second order statistics, select, based on the determined mobility status, one or more beam management parameters, and manage the one or more beams according to the selected one or more beam management parameters.

Some examples of the method, apparatuses, and non-transitory computer-readable medium described herein may further include operations, features, means, or instructions for receiving, from one or more sensors at the UE, orientation information, displacement information, or both and confirming, based on the orientation information, displacement information, or both, the mobility status associated with the set of second order statistics.

In some examples of the method, apparatuses, and non-transitory computer-readable medium described herein, the one or more sensors include a magnetometer, a gyroscope, an accelerometer, or any combination thereof.

In some examples of the method, apparatuses, and non-transitory computer-readable medium described herein, determining the mobility status may include operations, features, means, or instructions for determining that the UE may be stationary, determining that the UE may be in motion, determining a Doppler value for the UE, determining that the UE may be in rotation, determining that the UE may be not in rotation, or any combination thereof.

Some examples of the method, apparatuses, and non-transitory computer-readable medium described herein may further include operations, features, means, or instructions for measuring the one or more beam metrics for the one or more beams during a data collection window, identifying a triggering event, and resetting the data collection window based on identifying the triggering event.

In some examples of the method, apparatuses, and non-transitory computer-readable medium described herein, identifying the triggering event may include operations, features, means, or instructions for performing a handover procedure, performing a beam configuration update, or both.

In some examples of the method, apparatuses, and non-transitory computer-readable medium described herein, the one or more beam metrics include reference signal receive power, signal to noise ratio, reference signal received quality, or any combination thereof.

In some examples of the method, apparatuses, and non-transitory computer-readable medium described herein, the one or more beam management parameters include power hysteresis parameters, time hysteresis parameters, filtering coefficient values, or any combination thereof.

### BRIEF DESCRIPTION OF THE DRAWINGS

FIG. 1 illustrates an example of a wireless communications system that supports techniques for mobility detection for modem parameter selection in accordance with aspects of the present disclosure.

FIG. 2 illustrates an example of a wireless communications system that supports techniques for mobility detection for modem parameter selection in accordance with aspects of the present disclosure.

FIG. 3 illustrates an example of first order statistics and second order statistics that supports techniques for mobility detection for modem parameter selection in accordance with aspects of the present disclosure.

FIG. 4 illustrates an example of a process flow that supports techniques for mobility detection for modem parameter selection in accordance with aspects of the present disclosure.

FIGS. 5 and 6 show block diagrams of devices that support techniques for mobility detection for modem parameter selection in accordance with aspects of the present disclosure.

FIG. 7 shows a block diagram of a communications manager that supports techniques for mobility detection for modem parameter selection in accordance with aspects of the present disclosure.

FIG. 8 shows a diagram of a system including a device that supports techniques for mobility detection for modem parameter selection in accordance with aspects of the present disclosure.

FIGS. 9 and 10 show flowcharts illustrating methods that support techniques for mobility detection for modem parameter selection in accordance with aspects of the present disclosure.

### DETAILED DESCRIPTION

In some examples of a wireless communications system, a user equipment (UE) may communicate with other wireless devices (e.g., base stations, other UEs, or the like) via one or more beams. The UE may manage one or more beams (e.g., to select beams, refine beams, change beams, or the like) to maintain high quality communications with other devices. The UE may select one or more parameters for beam management. For instance, the UE may determine filtering coefficients for beam measurements, time hysteresis for beam switching, power hysteresis for beam switching, or the like. However, the effectiveness of selected parameters may change based on a mobility status of the UE. For example, a deeper filter, with large coefficient values, for beam measurements may improve beam management in a high Doppler scenario with little or no rotation by smoothing out Doppler and noise effects, avoiding ping-pong beam switching or cell handover procedures, or the like. However, in a rotational scenario (e.g., where the UE is rotating), the beam management may benefit from a beam measurement filter with smaller coefficient values, resulting in increased granularity for tracking the rotational effect of the UE on beam quality for a beam. Other parameters, such as time hysteresis, power hysteresis, etc., may provide different benefits for different selected parameter values. These benefits can be more fully exploited by applying different parameter values in different mobility status. If identical parameters are applied in all scenarios, instead of taking into account the mobility status of a UE, then the lack of flexibility based on mobility information may result in inefficient beam management, ping-pong beam selection or cell handover, poor beam quality, decreased quality of service, increased power expenditures, and reduced user experience.

In some examples, a UE may select modem parameters for beam management based on a motion status of the UE, which may result in improved performance, more efficient beam management, improved quality of service, and improved user experience. Selecting parameter values that are specific to a given mobility status may improve UE functionality and efficiency, conserve power, improve beam management, decrease system latency, improve the reliability of communications for the UE, and improve user experience. However, accurately selecting the appropriate parameter values for a mobility status may rely on accurately detecting the mobility status.

In some examples, to accurately, and in real time, determine a mobility status of a UE, the UE may perform filtering or post-processing on one or more beam metrics (e.g., reference signal receive power (RSRP), signal to noise ratio (SNR), reference signal receive quality (RSRQ), or the like) over time. The UE may generate first order statistics for the beam metrics, and may use the first order statistics to generate second order statistics. For example, the UE may perform a loop tracking procedure (e.g., may periodically monitor a service cell, a serving base station beam, and a serving UE beam) to generate instantaneous and mean values for a beam metric (e.g., RSRP, SNR, RSRQ, etc.). The UE may determine, based on the mean values for the beam metrics, second order statistics (e.g., beam variance for the beam metrics). Based on whether the second order statistics for the beam metrics converge, based on whether a detected beam metric converges at zero or a non-zero value, or any combination thereof, the UE may determine a mobility status for the UE. For instance, if the second order statistics of the beam metrics converge at zero, the UE may determine that the UE is stationary, has small Doppler value, has no rotation, etc. If the second order statistics of the beam metrics converge at a non-zero constant, the UE may determine that the UE has a Doppler value, but no rotation. If the second-order statistics diverge, then the UE may determine that the UE is rotating. The UE may select appropriate beam management parameter values based on the determined mobility status.

In some examples, the UE may confirm the determination made based on the second order statistics by receiving data from one or more sensors (e.g., accelerometer, magnetometer, gyroscope, etc.). The UE may select appropriate parameters for performing beam management functions based on the identified mobility status (e.g., as confirmed by the data from the sensors). The UE may constantly update the values of the beam metrics during a measurement window, and may reset the window at cell handover, after a beam configuration update (e.g., transmission configuration indicator (TCI) state update), or the like.

Aspects of the disclosure are initially described in the context of wireless communications systems. Aspects of the disclosure are further illustrated by and described with reference to wireless communications systems, beam metric calculations, and process flows. Aspects of the disclosure are further illustrated by and described with reference to apparatus diagrams, system diagrams, and flowcharts that relate to techniques for mobility detection for modem parameter selection.

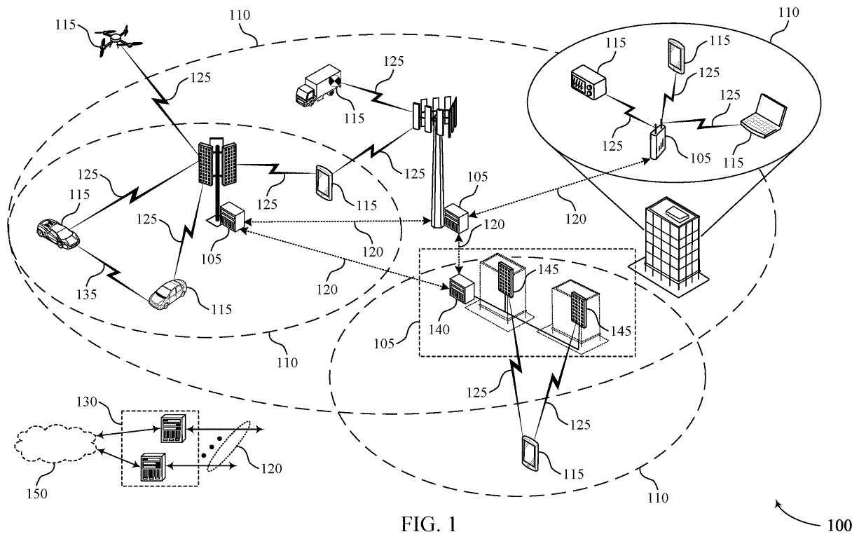

FIG. 1 illustrates an example of a wireless communications system 100 that supports techniques for mobility detection for modem parameter selection in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Generally, to determine a mobility status of a UE 115, the UE 115 may perform filtering or post-processing on one or more beam metrics (e.g., reference signal receive power (RSRP), signal to noise ratio (SNR), reference signal receive quality (RSRQ), or the like) over time. The UE 115 may generate first order statistics for the beam metrics, and may use the first order statistics to generate second order statistics. For example, the UE 115 may perform a loop tracking procedure (e.g., may periodically monitor a service cell, a serving base station beam, and a serving UE beam) to generate instantaneous and mean values for a beam metric (e.g., RSRP, SNR, RSRQ, etc.). The UE 115 may determine, based on the mean values for the beam metrics, second order statistics (e.g., beam variance for the beam metrics). Based on whether the second order statistics for the beam metrics converge, based on whether a detected beam metric converges at zero or a non-zero value, or any combination thereof, the UE 115 may determine a mobility status for the UE 115. For instance, if the second order statistics of the beam metrics converge at zero, the UE 115 may determine that the UE 115 is stationary, has small Doppler value, has no rotation, etc. If the second order statistics of the beam metrics converge at a non-zero constant, the UE 115 may determine that the UE 115 has a Doppler value, but no rotation. If the second-order statistics diverge, then the UE may determine that the UE 115 is rotating. The UE 115 may select appropriate beam management parameter values based on the determined mobility status.

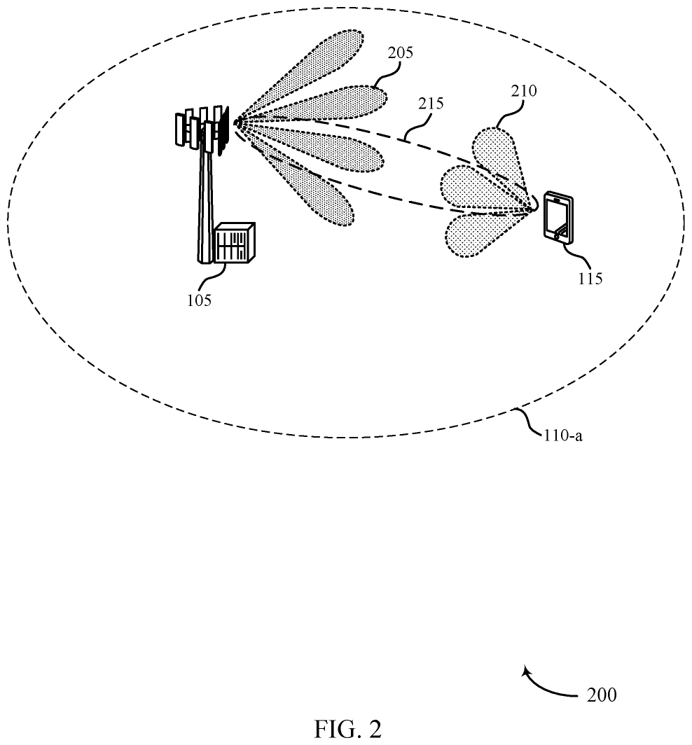

FIG. 2 illustrates an example of a wireless communications system 200 that supports techniques for mobility detection for modem parameter selection in accordance with aspects of the present disclosure. Wireless communications system 200 includes a base station 105 and a UE 115, each of which may be an example of the corresponding devices as described with reference to FIG. 1.

Wireless communications system 200 may support beamformed transmissions between base station 105 and UE 115. For example, wireless communications system 200 may operate using multiple communication beams. As a result, signal processing techniques, such as beamforming may be used to combine energy coherently and overcome path losses. By way of example, base station 105 may contain multiple antennas. In some cases, each antenna may transmit (or receive) a phase-shifted version of a signal such that the phase-shifted versions constructively interfere in some regions and destructively interfere in others. Weights may be applied to the various phase-shifted versions, e.g., in order to steer the transmissions in a desired direction. Such techniques (or similar techniques) may serve to increase the coverage area 110-a of the base station 105 or otherwise benefit wireless communications system 200.

Base station 105 may use beams 205 for communication and UE 115 may also use beams 210 for communication. Beams 205 and beams 210 may represent examples of beams over which data (or control information) may be transmitted or received according to beamforming techniques. Accordingly, each beam 205 may be directed from base station 105 toward a different region of the coverage area 110-a and in some cases, two or more beams may overlap. Beams 205 may be transmitted simultaneously or at different times. In either case, a UE 115 may be capable of receiving the information in one or more beams 205 via respective beams 210.

Similar to base station 105, UE 115 may include multiple antennas and may form one or more beams 210 through the use of various antenna arrays. The beams 210 may be used to receive transmissions from beams 205 (e.g., UE 115 may be positioned within wireless communications system 200 such that it receives beamformed transmissions associated with some beams 205). Such a scheme may be referred to as a receive-diversity scheme. In some cases, the beams 210 may receive beams 205 with various path loss and multipath effects included.

A beam 205 and a corresponding beam 210 may be referred to as an active beam 215, a beam pair, or beam pair link. Each beam pair (e.g., active beam 215) may include a serving beam 205 and a serving beam 210 (e.g., the beam pair on which the UE 115 and the base station 105 are currently communicating). The active beam 215 may be established via beam management, which may occur during a cell acquisition (e.g., through synchronization signals) or a beam refinement procedure where the UE 115 and base station 105 try various combinations of finer transmission beams and reception beams until a suitable active beam 215 is determined. An active beam 215 established for one or both of downlink and uplink communications may be referred to as a downlink or uplink active beam 215, respectively, and in some examples, an active beam may support both uplink and downlink communications. In some cases, each active beam 215 may be associated with a signal quality (e.g., such that UE 115 and base station 105 may preferentially communicate over an active beam 215 associated with a better signal quality) and each active beam 215 may carry one or more channels. Examples of such channels include the PDSCH, the PDCCH, the PUSCH, and the PUCCH.

UE 115 may manage one or more beams (e.g., to select beams, refine beams, change beams, or the like) to maintain high quality communications with other devices (e.g., base station 105). UE 115 may select one or more parameters for beam management. For instance, UE 115 may determine filtering coefficients for beam measurements, time hysteresis for beam switching, power hysteresis for beam switching, or the like. However, the effectiveness of selected parameters may be different for different mobility statuses of UE 115. For example, a deeper filter, with large coefficient values, for beam measurements may improve beam management in a high Doppler scenario with little or no rotation by smoothing out Doppler and noise effects, avoiding ping-pong beam switching or cell handover procedures, or the like. However, in a rotational scenario, UE 115 may improve beam management by applying a beam measurement filter with smaller coefficient values, resulting in increased granularity for tracking the rotational effect of UE 115 on beam quality for an active beam 215. Similarly, if UE 115 is in a Doppler scenario with no rotation, UE 115 may select longer time hysteresis values, which may smooth out Doppler and noise effects, avoid ping-pong beam switching or cell handovers. However, in a rotation scenario, UE 115 may select shorter time hysteresis, to track the effects of the rotation. If UE 115 is stationary, then UE 115 may improve beam management by selecting lower power hysteresis values, to avoid UE 115 being stuck on a single active beam 215 that is sub-optimal. However, if UE 115 is mobile (e.g., moving quickly or regularly across coverage area 110-a), then UE 115 may improve beam management by selecting higher power hysteresis values, to avoid frequency beam switching and cell handovers. These benefits can be more fully exploited by applying different parameter values in for different mobility statuses. If identical parameters are applied in all scenarios, instead of taking into account the mobility status of UE 115, then the lack of flexibility and mobility information may result in inefficient beam management, ping-pong beam selection or cell handover, poor beam quality, decreased quality of service, and reduced user experience. However, if UE 115 can determine and take into account mobility status in parameter selection, then UE 115 may more effectively and efficiently manage beams for specific, current mobility scenarios.

In some examples, UE 115 may select modem parameters for beam management based on a motion status of UE 115, which may result in improved performance, more efficient beam management, improved quality of service, and improved user experience. For example, if UE 115 is in a Doppler, non-rotation mobility scenario, UE 115 may select deeper filters with larger filter coefficient values, longer time hysteresis, or any combination thereof, to smooth out doppler effects and noise effects, and to avoid ping-pong beam switching or cell handovers. Or, if UE 115 is in a rotation scenario, UE 115 may select small filters with smaller filter coefficients, shorter time hysteresis, or any combination thereof, to track a rotational effect on UE 115. If UE 115 is stationary, UE 115 may use lower power hysteresis to avoid UE 115 getting stuck on a beam that is sub-optimal, while UE 115 may use higher power hysteresis if UE 115 is highly mobile to avoid highly frequent beam switching or cell handovers. Thus, selecting parameter values that are specific to a given mobility status may improve UE functionality and efficiency, conserve power, improve beam management, decrease system latency, improve the reliability of communications for UE 115, and improve user experience. If UE 115 inflexibly applies identical parameters to all scenarios (e.g., all mobility statuses), UE 115 may suffer performance degradation. However, accurately selecting the appropriate parameter values for a mobility status may rely on accurately detecting the mobility status. Some systems (e.g., conventional systems) may not incorporate mobility status information into beam management. Some communications systems (e.g., LTE systems, other systems, etc.) may not support detection of rotational motion.

In some examples, to accurately, and in real time, determine a mobility status, UE 115 may measure beam metrics and determine first order beam metric statistics and second order beam metric statistics indicative of mobility status. UE 115 may perform filtering/post-processing on constantly updated beam metrics (e.g., RSRP, SNR, RSRQ, or the like) over time. For example, UE 115 may perform loop tracking (e.g., frequency tracking loop (FTL), time tracking loop (TTL), automatic gain control (AGC), or the like) to generate first order statistics for one or more beam metrics. The loop tracking procedure may include periodically monitoring a service cell, a serving cell, a serving beam 205, a serving beam 210 (e.g., an active beam 215), or any combination thereof. The loop tracking procedure may generate one or more beam metrics. UE 115 may continually monitor to generate first order statistics (e.g., instantaneous values and mean values over time for a beam metric (e.g., RSRP, SNR, RSRQ, etc.).

UE 115 may determine, in real time based on the first order statistics (e.g., mean values for the beam metrics, second order statistic for the beam metrics. Second order statistics may include, for example, variance of first order statistics over time for the beam metrics. Based on whether the second order statistics for the beam metrics converge, based on whether a detected beam metric converges at zero or a non-zero value, or both, UE 115 may determine a mobility status for the UE. For instance, if the second order statistics of the beam metrics converge at zero, the UE may determine that the UE is stationary, has a small Doppler value, has no rotation, etc. If the second order statistics of the beam metrics converge at a non-zero constant, the UE may determine that the UE has a Doppler value, but no rotation. If the second-order statistics diverge, then the UE may determine that the UE is rotating. The UE may select appropriate beam management parameter values based on the determined mobility status.

In some examples, UE 115 may utilize assistance from external sensors, and may apply fusing techniques between the external sensor data and the second order statistics data. In some examples, UE 115 may confirm the determination made based on the second order statistics by receiving data from one or more sensors (e.g., accelerometer, magnetometer, gyroscope, etc.). UE 115 may select appropriate parameters for performing beam management functions based on the identified mobility status (e.g., as confirmed by the data from the sensors). Or, in some examples, UE 115 may fuse or otherwise combine the received sensor data with the second order statistics data.

UE 115 may constantly update the values of the beam metrics during a measurement window, and may reset the measurement window when a triggering event occurs (e.g., at cell handover, after a beam configuration update (e.g., transmission configuration indicator (TCI) state update), or the like).

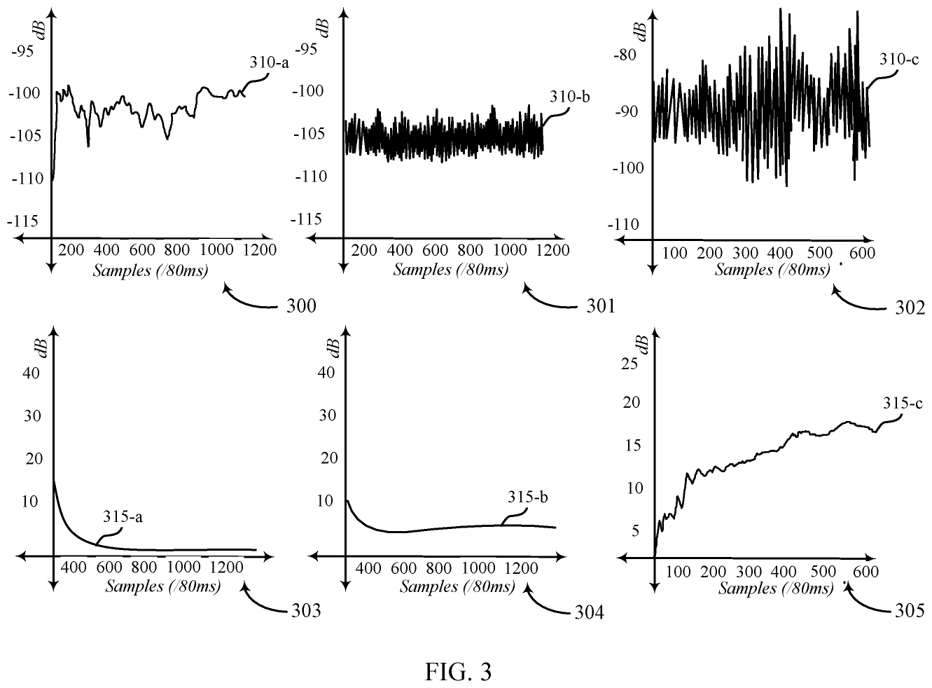

FIG. 3 illustrates an example of first order statistics 300, first order statistics 301, first order statistics 302, second order statistics 303, second order statistics 304, and second order statistics 305, that support techniques for mobility detection for modem parameter selection in accordance with aspects of the present disclosure. In some examples, first order statistics and second order statistics illustrated with reference to FIG. 3 may implement or be implemented by aspects of wireless communications systems 100 and 200. For example, a UE, which may be an example of corresponding devices described with reference to FIG. 1 and FIG. 2, may perform beam metric measurements and calculations, as illustrated and described with reference to FIG. 3.

In some examples, as described in greater detail with reference to FIG. 2, a UE may perform one or more calculations to generate first order statistics and second order statistics for one or more beam metrics. The UE may generate statistics for one beam metric of a set of available beam metrics, or may generate statistics for multiple beam metrics (e.g., separately, or in combination). Beam metrics may include RSRP, RSRQ, SNR, or the like. As illustrated with reference to FIG. 3, the UE may perform beam measurements and generate first order statistics and second order statistics for RSRP (in dB).

The UE may generate first order statistics by calculating, over a number of iterations n instantaneous beam metrics (e.g., xₙ), and a mean beam metrics (e.g., μₙ). Thus, first order statistics xₙ (e.g., mean beam metric over time) may be determined as follows in equation 1:

$${μ}_{n} = {μ}_{n - 1} + \frac{{x}_{n} - {μ}_{n - 1}}{n} \qquad Equation 1$$

Having determined first order statistics, the UE may rely on the first order statistics to generate second order statistics. For example, the UE may determine a second order statistic (e.g., a variance of the first order statistic) by calculating a variance (e.g., σₙ²) of the beam metric over time, as follows in equation 2:

$${σ}_{n}^{2} = {σ}_{n - 1}^{2} + \frac{{( {x}_{n} - {μ}_{n - 1} )}^{2}}{n} - \frac{{σ}_{n - 1}^{2}}{n - 1} \qquad Equation 2$$

For example, the UE may generate first order statistics 300 by measuring RSRP over time (e.g., taking samples) and applying Equation 2. First order statistics 300 may indicate raw RSRP 310-a over time. The mean RSRP for RSRP 310-a may be relatively constant (e.g., at or close to, for instance, −102 dBs). The UE may generate second order statistics 303 (e.g., using Equation 2) based on first order statistics 300. Second order statistics 303 may indicate a variance of the first order statistics (e.g., raw RSRP 310-a) over time. Second order statistics (e.g., RSRP variance 315-a) may converge at or near zero dBs. In such examples, the UE may determine that the UE station, has a small Doppler value, and no rotation. The UE may select appropriate mode parameter values for this mobility status.

In some examples, the UE may generate first order statistics 301 by measuring RSRP over time (e.g., taking samples) and applying Equation 1. First order statistics 301 may indicate raw RSRP 310-b over time. The mean RSRP for RSRP 310-b may be, for instance, −104 dB). The UE may generate second order statistics 304 (e.g., using Equation 2) based on first order statistics 301. Second order statistics 304 may indicate a variance of the first order statistics (e.g., raw RSRP 310-b) over time. Second order statistics (e.g., RSRP variance 315-b) may converge at or near a non-zero value (e.g., at or about 4 dBs). In such examples, the UE may determine that the UE has a Doppler value and no rotation. The UE may select appropriate mode parameter values for this mobility status.

In some examples, the UE may generate first order statistics 302 by measuring RSRP over time (e.g., taking samples) and applying Equation 1. First order statistics 302 may indicate raw RSRP 310-c over time. The mean RSRP for RSRP 310-c may be, for instance, −93 dB). The UE may generate second order statistics 305 (e.g., using Equation 2) based on first order statistics 302. Second order statistics 305 may indicate a variance of the first order statistics (e.g., raw RSRP 310-c) over time. Second order statistics (e.g., RSRP variance 315-c) may diverge (e.g., may not converge). In such examples, the UE may determine that the UE is rotating. The UE may select appropriate mode parameter values for this mobility status.

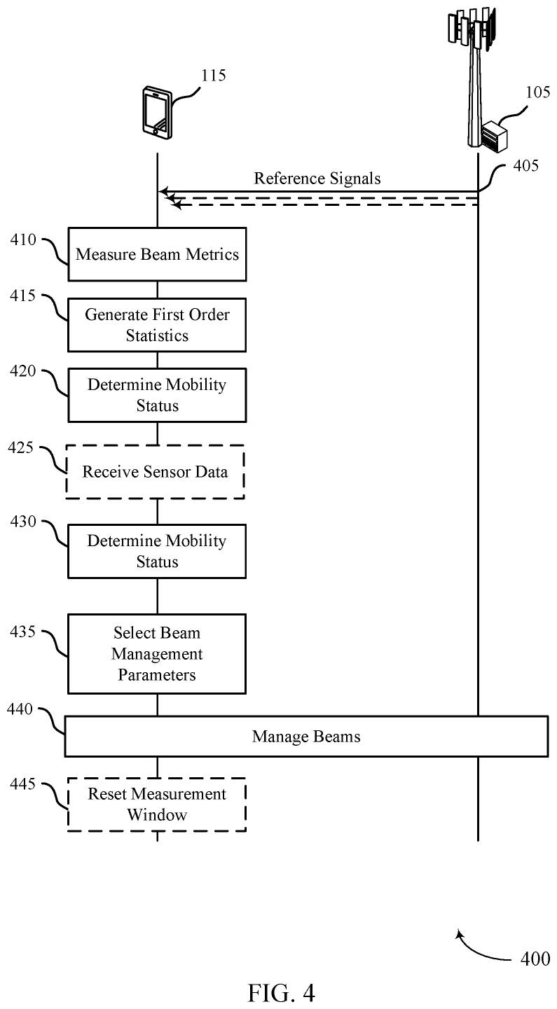

FIG. 4 illustrates an example of a process flow 400 that supports techniques for mobility detection for modem parameter selection in accordance with aspects of the present disclosure. Process flow 400 may include a UE 115 and a base station 105, which may be examples of corresponding devices described with reference to FIGS. 1-3. Process flow 400 may implement or be implemented by aspects of FIGS. 1-3.

At 405, base station 105 may transmit, and UE 115 may receive, one or more signals. The signals may be, for example, reference signals. Base station 105 may transmit the reference signals on an active beam pair including a serving base station beam and a serving UE beam (e.g., a transmit beam and a receive beam of a beam pair or beam pair link).

At 410, UE 115 may measure one or more beam metrics for one or more beams on which reference signals are received at 410. For example, UE 115 may measure RSRP, RSRQ, SNR, or the like.

AT 415, UE 115 may generate first order statistics for the beam metrics (e.g., using Equation 1 as described with reference to FIG. 3). The first order statistics may include raw or real time beam metrics, mean beam metrics, or the like, over multiple iterations of Equation 1.

At 420, UE 115 may generate a set of second order statistics for the beam metric, based at least in part on the first order statistics generated at 415 (e.g., using Equation 2). The second order statistics may include, for example, a variance of the beam metric over time.

At 425, UE 115 may receive sensor data from one or more external sensors (e.g., magnetometer, gyroscope, accelerometer, or the like). The sensor data may include orientation information, displacement information, or both. In some examples, UE 115 may use the sensor data to confirm the second order statistics determined at 420. In some examples, UE 115 may fuse or otherwise combine the sensor data with the second order statistics.

At 430, UE 115 may determine a mobility status (e.g., Doppler, rotation, stationary, etc.) for UE 115. The mobility status may be based on the second order statistics (e.g., whether the second order statistics diverge, converge at or around zero, converge on a non-zero value, or any combination thereof). The mobility status may be, in some examples, based on the sensor data. For example, UE 115 may determine a mobility status based solely on the sensor data, based solely on the second order statistics, or based on a combination of the sensor data and the second order statistics.

At 435, UE 115 may select beam management parameters based on the determined mobility status. The UE may select time hysteresis parameters, power hysteresis parameters, beam measurement filtering coefficients, or any combination thereof, based on the mobility parameters, as described in greater detail with reference to FIG. 2.

At 440, UE 115 may mange one or more beams according to the selected beam management parameters. For example, UE 115 may filter or otherwise measure beams, change beams, initiate a cell handover or a beam handover, refine beams, select beams, or any combination thereof, based on the selected beam management parameters.

In some examples, UE 115 may perform one or more actions described herein (e.g., measure beam metrics, generate first order statistics and second order statistics, determine mobility status of UE 115, select beam management parameters, and manage beams accordingly), during a measurement window (e.g., a data collection window). UE 115 may identify a triggering event (e.g., performing a handover procedure performing a beam configuration update (e.g., receiving a TCI state update, selecting or activating one or more TCI states, etc.), or any combination thereof). Upon identifying the triggering event, UE 115 may reset (e.g., restart) the measurement window or the data collection window (e.g., at 445).

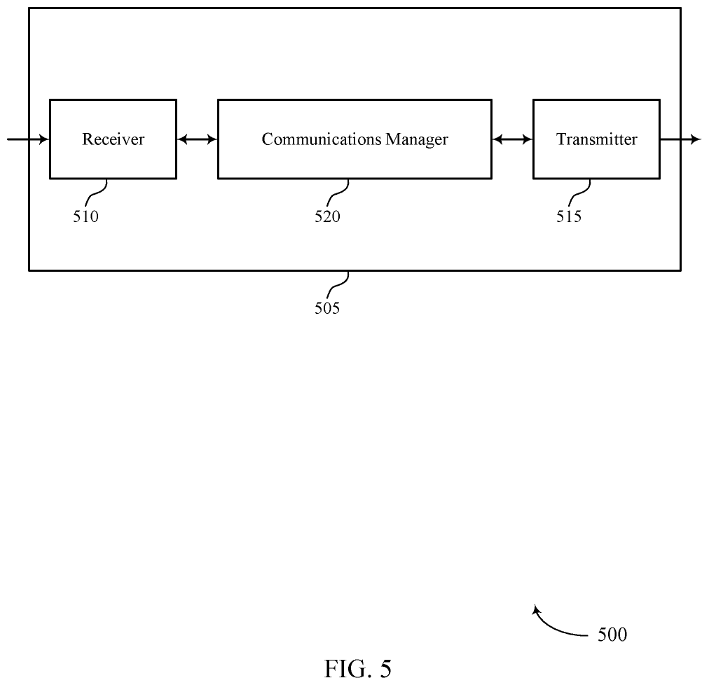

FIG. 5 shows a block diagram 500 of a device 505 that supports techniques for mobility detection for modem parameter selection in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for mobility detection for modem parameter selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for mobility detection for modem parameter selection). In some examples, the transmitter 515 may be co-located with a receiver 510 in a transceiver component. The transmitter 515 may utilize a single antenna or a set of multiple antennas.

The communications manager 520, the receiver 510, the transmitter 515, or various combinations thereof or various components thereof may be examples of means for performing various aspects of techniques for mobility detection for modem parameter selection as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for generating, based at least in part on one or more beam metrics for one or more beams, a set of first order statistics associated with the one or more beam metrics. The communications manager 520 may be configured as or otherwise support a means for generating, based at least in part on the set of first order statistics, a set of second order statistics associated with the one or more beam metrics. The communications manager 520 may be configured as or otherwise support a means for determining a mobility status of the UE associated with the set of second order statistics. The communications manager 520 may be configured as or otherwise support a means for selecting, based on the determined mobility status, one or more beam management parameters. The communications manager 520 may be configured as or otherwise support a means for managing the one or more beams according to the selected one or more beam management parameters.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for selecting modem parameter values based on mobility status, resulting in improved SNR, improved efficiency, improved channel quality, decreased system latency, more efficient use of computational resources, and improved user experience.

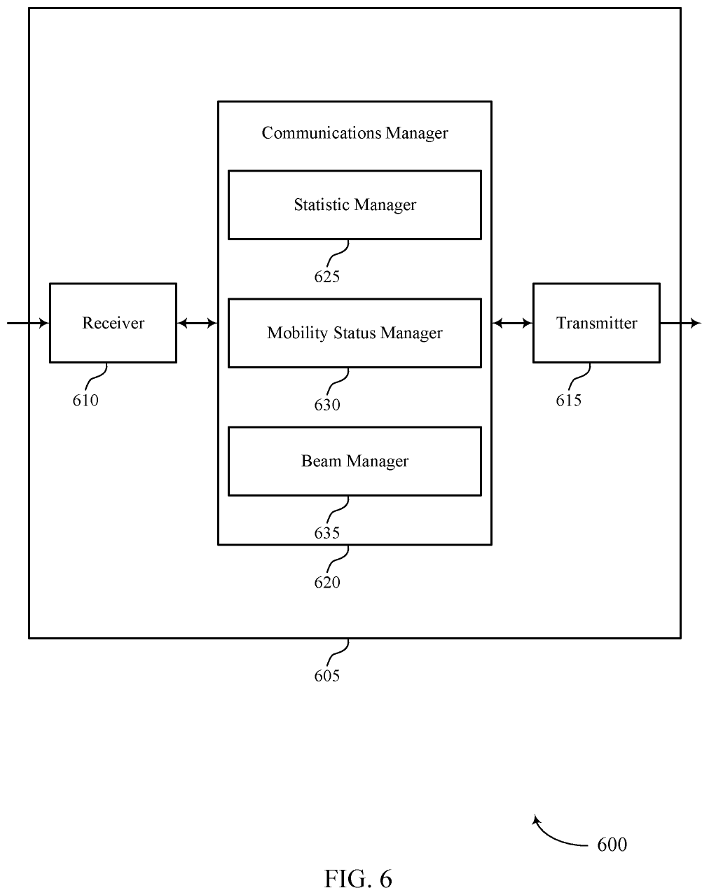

FIG. 6 shows a block diagram 600 of a device 605 that supports techniques for mobility detection for modem parameter selection in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for mobility detection for modem parameter selection). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for mobility detection for modem parameter selection). In some examples, the transmitter 615 may be co-located with a receiver 610 in a transceiver component. The transmitter 615 may utilize a single antenna or a set of multiple antennas.

The device 605, or various components thereof, may be an example of means for performing various aspects of techniques for mobility detection for modem parameter selection as described herein. For example, the communications manager 620 may include a Statistic Manager 625, a mobility status manager 630, a beam manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The Statistic Manager 625 may be configured as or otherwise support a means for generating, based on one or more beam metrics for one or more beams, a set of first order statistics associated with the one or more beam metrics. The Statistic Manager 625 may be configured as or otherwise support a means for generating, based on the set of first order statistics, a set of second order statistics associated with the one or more beam metrics. The mobility status manager 630 may be configured as or otherwise support a means for determining a mobility status of the UE associated with the set of second order statistics. The beam manager 635 may be configured as or otherwise support a means for selecting, based on the determined mobility status, one or more beam management parameters. The beam manager 635 may be configured as or otherwise support a means for managing the one or more beams according to the selected one or more beam management parameters.

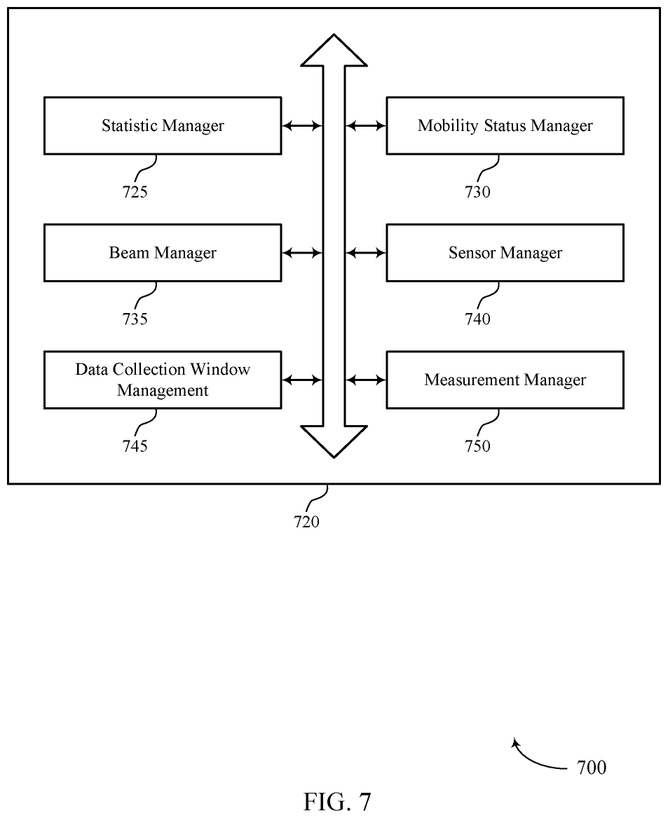

FIG. 7 shows a block diagram 700 of a communications manager 720 that supports techniques for mobility detection for modem parameter selection in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for mobility detection for modem parameter selection as described herein. For example, the communications manager 720 may include a Statistic Manager 725, a mobility status manager 730, a beam manager 735, a sensor manager 740, a data collection window management 745, a measurement manager 750, or any combination thereof. Each of these components may communicate, directly or indirectly, with one another (e.g., via one or more buses).

The communications manager 720 may support wireless communications at a UE in accordance with examples as disclosed herein. The Statistic Manager 725 may be configured as or otherwise support a means for generating, based on one or more beam metrics for one or more beams, a set of first order statistics associated with the one or more beam metrics. In some examples, the Statistic Manager 725 may be configured as or otherwise support a means for generating, based on the set of first order statistics, a set of second order statistics associated with the one or more beam metrics. The mobility status manager 730 may be configured as or otherwise support a means for determining a mobility status of the UE associated with the set of second order statistics. The beam manager 735 may be configured as or otherwise support a means for selecting, based on the determined mobility status, one or more beam management parameters. In some examples, the beam manager 735 may be configured as or otherwise support a means for managing the one or more beams according to the selected one or more beam management parameters.

In some examples, the sensor manager 740 may be configured as or otherwise support a means for receiving, from one or more sensors at the UE, orientation information, displacement information, or both. In some examples, the mobility status manager 730 may be configured as or otherwise support a means for confirming, based on the orientation information, displacement information, or both, the mobility status associated with the set of second order statistics.

In some examples, the one or more sensors include a magnetometer, a gyroscope, an accelerometer, or any combination thereof.

In some examples, to support determining the mobility status, the mobility status manager 730 may be configured as or otherwise support a means for determining that the UE is stationary, determining that the UE is in motion, determining a Doppler value for the UE, determining that the UE is in rotation, determining that the UE is not in rotation, or any combination thereof.

In some examples, the data collection window management 745 may be configured as or otherwise support a means for measuring the one or more beam metrics for the one or more beams during a data collection window. In some examples, the measurement manager 750 may be configured as or otherwise support a means for identifying a triggering event. In some examples, the data collection window management 745 may be configured as or otherwise support a means for resetting the data collection window based on identifying the triggering event.

In some examples, to support identifying the triggering event, the measurement manager 750 may be configured as or otherwise support a means for performing a handover procedure, performing a beam configuration update, or both.

In some examples, the one or more beam metrics include reference signal receive power, signal to noise ratio, reference signal received quality, or any combination thereof.

In some examples, the one or more beam management parameters include power hysteresis parameters, time hysteresis parameters, filtering coefficient values, or any combination thereof.

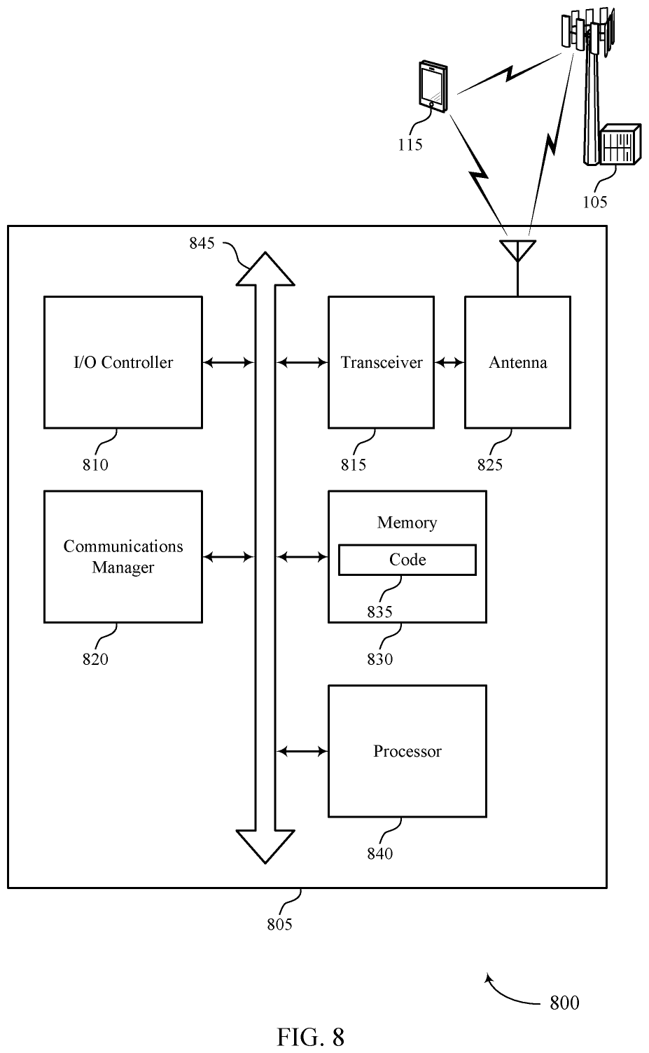

FIG. 8 shows a diagram of a system 800 including a device 805 that supports techniques for mobility detection for modem parameter selection in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for mobility detection for modem parameter selection). For example, the device 805 or a component of the device 805 may include a processor 840 and memory 830 coupled with the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for generating, based at least in part on one or more beam metrics for one or more beams, a set of first order statistics associated with the one or more beam metrics. The communications manager 820 may be configured as or otherwise support a means for generating, based at least in part on the set of first order statistics, a set of second order statistics associated with the one or more beam metrics. The communications manager 820 may be configured as or otherwise support a means for determining a mobility status of the UE associated with the set of second order statistics. The communications manager 820 may be configured as or otherwise support a means for selecting, based on the determined mobility status, one or more beam management parameters. The communications manager 820 may be configured as or otherwise support a means for managing the one or more beams according to the selected one or more beam management parameters.

By including or configuring the communications manager 820 in accordance with examples as described herein, the device 805 may support techniques for selecting modem parameter values based on mobility status, resulting in improved SNR, improved efficiency, improved channel quality, decreased system latency, more efficient use of computational resources, and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for mobility detection for modem parameter selection as described herein, or the processor 840 and the memory 830 may be otherwise configured to perform or support such operations.

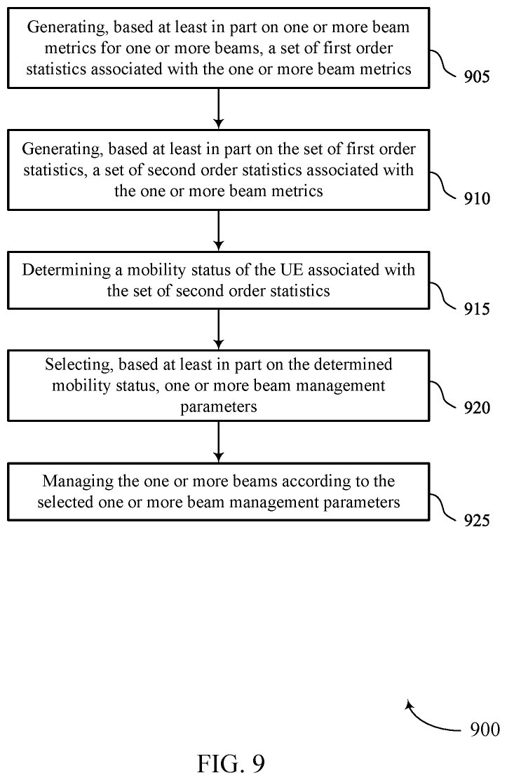

FIG. 9 shows a flowchart illustrating a method 900 that supports techniques for mobility detection for modem parameter selection in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include generating, based on one or more beam metrics for one or more beams, a set of first order statistics associated with the one or more beam metrics. The operations of 905 may be performed in accordance with examples as disclosed herein. In some examples, aspects of the operations of 905 may be performed by a Statistic Manager 725 as described with reference to FIG. 7.

At 910, the method may include generating, based on the set of first order statistics, a set of second order statistics associated with the one or more beam metrics. The operations of 910 may be performed in accordance with examples as disclosed herein. In some examples, aspects of the operations of 910 may be performed by a Statistic Manager 725 as described with reference to FIG. 7.

At 915, the method may include determining a mobility status of the UE associated with the set of second order statistics. The operations of 915 may be performed in accordance with examples as disclosed herein. In some examples, aspects of the operations of 915 may be performed by a mobility status manager 730 as described with reference to FIG. 7.

At 920, the method may include selecting, based on the determined mobility status, one or more beam management parameters. The operations of 920 may be performed in accordance with examples as disclosed herein. In some examples, aspects of the operations of 920 may be performed by a beam manager 735 as described with reference to FIG. 7.

At 925, the method may include managing the one or more beams according to the selected one or more beam management parameters. The operations of 925 may be performed in accordance with examples as disclosed herein. In some examples, aspects of the operations of 925 may be performed by a beam manager 735 as described with reference to FIG. 7.

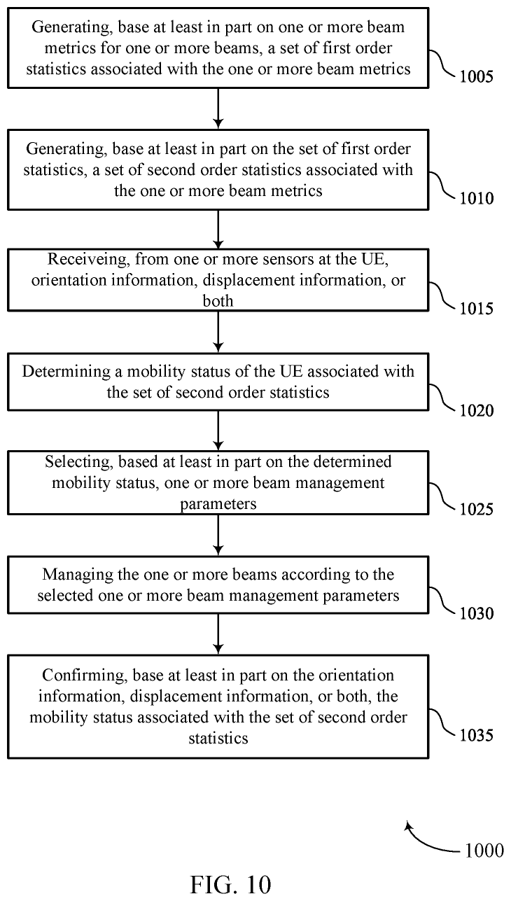

FIG. 10 shows a flowchart illustrating a method 1000 that supports techniques for mobility detection for modem parameter selection in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include generating, based on one or more beam metrics for one or more beams, a set of first order statistics associated with the one or more beam metrics. The operations of 1005 may be performed in accordance with examples as disclosed herein. In some examples, aspects of the operations of 1005 may be performed by a Statistic Manager 725 as described with reference to FIG. 7.

At 1010, the method may include generating, based on the set of first order statistics, a set of second order statistics associated with the one or more beam metrics. The operations of 1010 may be performed in accordance with examples as disclosed herein. In some examples, aspects of the operations of 1010 may be performed by a Statistic Manager 725 as described with reference to FIG. 7.

At 1015, the method may include receiving, from one or more sensors at the UE, orientation information, displacement information, or both. The operations of 1015 may be performed in accordance with examples as disclosed herein. In some examples, aspects of the operations of 1015 may be performed by a sensor manager 740 as described with reference to FIG. 7.

At 1020, the method may include determining a mobility status of the UE associated with the set of second order statistics. The operations of 1020 may be performed in accordance with examples as disclosed herein. In some examples, aspects of the operations of 1020 may be performed by a mobility status manager 730 as described with reference to FIG. 7.

At 1025, the method may include selecting, based on the determined mobility status, one or more beam management parameters. The operations of 1025 may be performed in accordance with examples as disclosed herein. In some examples, aspects of the operations of 1025 may be performed by a beam manager 735 as described with reference to FIG. 7.

At 1030, the method may include managing the one or more beams according to the selected one or more beam management parameters. The operations of 1030 may be performed in accordance with examples as disclosed herein. In some examples, aspects of the operations of 1030 may be performed by a beam manager 735 as described with reference to FIG. 7.

At 1035, the method may include confirming, based on the orientation information, displacement information, or both, the mobility status associated with the set of second order statistics. The operations of 1035 may be performed in accordance with examples as disclosed herein. In some examples, aspects of the operations of 1035 may be performed by a mobility status manager 730 as described with reference to FIG. 7.

The following provides an overview of aspects of the present disclosure:

Aspect 1: A method for wireless communications at a UE, comprising: generating, based at least in part on one or more beam metrics for one or more beams, a set of first order statistics associated with the one or more beam metrics; generating, based at least in part on the set of first order statistics, a set of second order statistics associated with the one or more beam metrics; determining a mobility status of the UE associated with the set of second order statistics; selecting, based at least in part on the determined mobility status, one or more beam management parameters; and managing the one or more beams according to the selected one or more beam management parameters.

Aspect 2: The method of aspect 1, further comprising: receiving, from one or more sensors at the UE, orientation information, displacement information, or both; confirming, based at least in part on the orientation information, displacement information, or both, the mobility status associated with the set of second order statistics.

Aspect 3: The method of aspect 2, wherein the one or more sensors comprise a magnetometer, a gyroscope, an accelerometer, or any combination thereof.

Aspect 4: The method of any of aspects 1 through 3, wherein determining the mobility status comprises: determining that the UE is stationary, determining that the UE is in motion, determining a Doppler value for the UE, determining that the UE is in rotation, determining that the UE is not in rotation, or any combination thereof.

Aspect 5: The method of any of aspects 1 through 4, further comprising: measuring the one or more beam metrics for the one or more beams during a data collection window; identifying a triggering event; and resetting the data collection window based at least in part on identifying the triggering event.

Aspect 6: The method of aspect 5, wherein identifying the triggering event comprises: performing a handover procedure, performing a beam configuration update, or both.

Aspect 7: The method of any of aspects 1 through 6, wherein the one or more beam metrics comprise reference signal receive power, signal to noise ratio, reference signal received quality, or any combination thereof.

Aspect 8: The method of any of aspects 1 through 7, wherein the one or more beam management parameters comprise power hysteresis parameters, time hysteresis parameters, filtering coefficient values, or any combination thereof.

Aspect 9: An apparatus for wireless communications at a UE, comprising a processor; memory coupled with the processor; and instructions stored in the memory and executable by the processor to cause the apparatus to perform a method of any of aspects 1 through 8.

Aspect 10: An apparatus for wireless communications at a UE, comprising at least one means for performing a method of any of aspects 1 through 8.

Aspect 11: A non-transitory computer-readable medium storing code for wireless communications at a UE, the code comprising instructions executable by a processor to perform a method of any of aspects 1 through 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
generating, based at least in part on one or more beam metrics for one or more beams, a set of first order statistics associated with the one or more beam metrics;
generating, based at least in part on the set of first order statistics, a set of second order statistics associated with the one or more beam metrics;
determining a mobility status of the UE associated with the set of second order statistics;
selecting, based at least in part on the determined mobility status, one or more beam management parameters; and
managing the one or more beams according to the selected one or more beam management parameters.

2. The method of claim 1, further comprising:
receiving, from one or more sensors at the UE, orientation information, displacement information, or both; and
confirming, based at least in part on the orientation information, displacement information, or both, the mobility status associated with the set of second order statistics.

3. The method of claim 2, wherein the one or more sensors comprise a magnetometer, a gyroscope, an accelerometer, or any combination thereof.

4. The method of claim 1, wherein determining the mobility status comprises:
determining that the UE is stationary, determining that the UE is in motion, determining a Doppler value for the UE, determining that the UE is in rotation, determining that the UE is not in rotation, or any combination thereof.

5. The method of claim 1, further comprising:
measuring the one or more beam metrics for the one or more beams during a data collection window;
identifying a triggering event; and
resetting the data collection window based at least in part on identifying the triggering event.

6. The method of claim 5, wherein identifying the triggering event comprises:
performing a handover procedure, performing a beam configuration update, or both.

7. The method of claim 1, wherein the one or more beam metrics comprise reference signal receive power, signal to noise ratio, reference signal received quality, or any combination thereof.

8. The method of claim 1, wherein the one or more beam management parameters comprise power hysteresis parameters, time hysteresis parameters, filtering coefficient values, or any combination thereof.

9. An apparatus for wireless communications at a user equipment (UE), comprising:
a processor;
memory coupled with the processor; and
instructions stored in the memory and executable by the processor to cause the apparatus to:
generate, based at least in part on one or more beam metrics for one or more beams, a set of first order statistics associated with the one or more beam metrics;
generate, based at least in part on the set of first order statistics, a set of second order statistics associated with the one or more beam metrics;
determine a mobility status of the UE associated with the set of second order statistics;
select, based at least in part on the determined mobility status, one or more beam management parameters; and
manage the one or more beams according to the selected one or more beam management parameters.

10. The apparatus of claim 9, wherein the instructions are further executable by the processor to cause the apparatus to:
receive, from one or more sensors at the UE, orientation information, displacement information, or both; and
confirm, based at least in part on the orientation information, displacement information, or both, the mobility status associated with the set of second order statistics.

11. The apparatus of claim 10, wherein the one or more sensors comprise a magnetometer, a gyroscope, an accelerometer, or any combination thereof.

12. The apparatus of claim 9, wherein the instructions to determine the mobility status are executable by the processor to cause the apparatus to:
determine that the UE is stationary, determining that the UE is in motion, determining a Doppler value for the UE, determining that the UE is in rotation, determining that the UE is not in rotation, or any combination thereof.

13. The apparatus of claim 9, wherein the instructions are further executable by the processor to cause the apparatus to:
measure the one or more beam metrics for the one or more beams during a data collection window;
identify a triggering event; and
reset the data collection window based at least in part on identifying the triggering event.

14. The apparatus of claim 13, wherein the instructions to identify the triggering event are executable by the processor to cause the apparatus to:
perform a handover procedure, performing a beam configuration update, or both.

15. The apparatus of claim 9, wherein the one or more beam metrics comprise reference signal receive power, signal to noise ratio, reference signal received quality, or any combination thereof.

16. The apparatus of claim 9, wherein the one or more beam management parameters comprise power hysteresis parameters, time hysteresis parameters, filtering coefficient values, or any combination thereof.

17. An apparatus for wireless communications at a user equipment (UE), comprising:
means for generating, based at least in part on one or more beam metrics for one or more beams, a set of first order statistics associated with the one or more beam metrics;
means for generating, based at least in part on the set of first order statistics, a set of second order statistics associated with the one or more beam metrics;
means for determining a mobility status of the UE associated with the set of second order statistics;
means for selecting, based at least in part on the determined mobility status, one or more beam management parameters; and
means for managing the one or more beams according to the selected one or more beam management parameters.

18. The apparatus of claim 17, further comprising:
means for receiving, from one or more sensors at the UE, orientation information, displacement information, or both; and
means for confirming, based at least in part on the orientation information, displacement information, or both, the mobility status associated with the set of second order statistics.

19. The apparatus of claim 18, wherein:
the one or more sensors comprise a magnetometer, a gyroscope, an accelerometer, or any combination thereof.

20. The apparatus of claim 17, wherein the means for determining the mobility status comprise:
means for determining that the UE is stationary, determining that the UE is in motion, determining a Doppler value for the UE, determining that the UE is in rotation, determining that the UE is not in rotation, or any combination thereof.

21. The apparatus of claim 17, further comprising:
means for measuring the one or more beam metrics for the one or more beams during a data collection window;
means for identifying a triggering event; and
means for resetting the data collection window based at least in part on identifying the triggering event.

22. The apparatus of claim 21, wherein the means for identifying the triggering event comprise:
means for performing a handover procedure, performing a beam configuration update, or both.

23. The apparatus of claim 17, wherein:
the one or more beam metrics comprise reference signal receive power, signal to noise ratio, reference signal received quality, or any combination thereof.

24. The apparatus of claim 17, wherein:
the one or more beam management parameters comprise power hysteresis parameters, time hysteresis parameters, filtering coefficient values, or any combination thereof.

25. A non-transitory computer-readable medium storing code for wireless communications at a user equipment (UE), the code comprising instructions executable by a processor to:
generate, based at least in part on one or more beam metrics for one or more beams, a set of first order statistics associated with the one or more beam metrics;
generate, based at least in part on the set of first order statistics, a set of second order statistics associated with the one or more beam metrics;
determine a mobility status of the UE associated with the set of second order statistics;
select, based at least in part on the determined mobility status, one or more beam management parameters; and
manage the one or more beams according to the selected one or more beam management parameters.

26. The non-transitory computer-readable medium of claim 25, wherein the instructions are further executable by the processor to:
receive, from one or more sensors at the UE, orientation information, displacement information, or both; and
confirm, based at least in part on the orientation information, displacement information, or both, the mobility status associated with the set of second order statistics.

27. The non-transitory computer-readable medium of claim 26, wherein the one or more sensors comprise a magnetometer, a gyroscope, an accelerometer, or any combination thereof.

28. The non-transitory computer-readable medium of claim 25, wherein the instructions to determine the mobility status are executable by the processor to:
determine that the UE is stationary, determining that the UE is in motion, determining a Doppler value for the UE, determining that the UE is in rotation, determining that the UE is not in rotation, or any combination thereof.

29. The non-transitory computer-readable medium of claim 25, wherein the instructions are further executable by the processor to:
measure the one or more beam metrics for the one or more beams during a data collection window;
identify a triggering event; and
reset the data collection window based at least in part on identifying the triggering event.

30. The non-transitory computer-readable medium of claim 29, wherein the instructions to identify the triggering event are executable by the processor to:
perform a handover procedure, performing a beam configuration update, or both.
